(19) United States
(12) Patent Application Publication
(10) Pub. No.: US 2026/0346916 A1
(43) Pub. Date: Nov. 5, 2026

(54) VEHICLE SUSPENSION KNUCKLE WITH ASYMMETRIC SHELL-LIKE SHAPE

(71) Applicant: GREDE LLC, Southfield, MI (US)

(72) Inventors: Mark C. JOHNSTON, Southfield, MI (US); Jeff PAXTON, Southfield, MI (US); Sandeep MAHADIK, Southfield, MI (US); Sridhar SETTY, Southfield, MI (US); Shrivallabh KHAIRNAR, Southfield, MI (US)

(21) Appl. No.: 19/486,611

(22) PCT Filed: May 29, 2024
(86) PCT No.: PCT/US2024/031421

§ 371 Date: Nov. 21, 2025

Related U.S. Application Data
(60) Provisional application No. 63/469,614, filed on May 30, 2023.

(51) Int. Cl. B62D 7/18

(52) U.S. Cl. CPC B62D 7/18

(57) ABSTRACT

A steering knuckle with reduced mass and similar or improved strength, stiffness, and durability is contemplated. The knuckle relies upon a mussell-shell shaped body that is three dimensionally asymmetric and constantly curving, except for the hard connection points commonly encountered in such components. The body is made of a single-layer wall that has a substantially similar or constant thickness, and its peripheral shape is non-linear.

### CROSS REFERENCE TO RELATED APPLICATIONS

This application claims priority to U.S. provisional patent application Ser. No. 63/469,614 filed on May 30, 2023, which is incorporated by reference herein.

### TECHNICAL FIELD

This application relates to components for vehicle suspension systems and, more specifically, knuckle-connection device based on an asymmetric shell-like body that enables connection points along multiple discrete planes while simultaneously accommodating and distributing anticipated loads along the shell-like body.

### BACKGROUND

Vehicle suspension systems must support a vehicle's weight while maximizing traction of the tire to the ground, allowing/improving steering stability, and dampening shock commonly encountered based on road conditions and/or loads carried by the vehicle. “Knuckles” serves as mounting points for the wheel (either via a hub or spindle), along with the upper and lower ball joints (or equivalent suspension components) associated with the wheel assembly. Typically, the steering knuckle is positioned behind the front wheels proximate to the axel so as to facilitate turning of the wheels. Knuckles are usually designed to also accommodate/connect to other vehicle systems, such as braking systems, sensors, and the like. As such, the knuckle necessarily includes a plurality of flattened mounting surfaces aligned in different planes that interface with discrete areas of the knuckle.

United States patent publication 2023/0249744 and European patent publication EP37207458A1 provide examples of conventional knuckle designs relying on “shell” designs. The former relies on a “bulged portion” positioned centrally with various radial projections extending therefrom, while the latter contemplates a “shell element” extending away from a main hollowed body.

Other examples of past knuckle designs include: U.S. Pat. Nos. 2,341,811; 4,119,167; 4,618,159; and 5,897,124, as well as United States patent publication 2022/0258797, British patent GB 2132580B, and Japanese patents JP 1987014432B1 and JP1987014432B2. All of the aforementioned patents are incorporated by reference as additional background information regarding the design, construction, and related considerations for vehicle suspension components and knuckles/connecting devices.

Owing to increasingly stringent fuel efficiency standards, vehicle manufacturers want lighter components without losing strength, durability, and functionality. However, conventional approaches, such as “stick build” modeling, do not always produce the most efficient shape. In fact, many of the aforementioned patents appear to rely on (or are representative of the output produced by) the stick build approach.

In stick built components, the “hard” connection points (e.g., upper and lower ball joint, caliper ears, hub/spindle mounting, steering arm, sensor connections, etc.) dictate a linear or curvilinear body shape for a basic frame or skeleton around which the knuckle will be built. Thereafter, through modeling, testing, or experience (e.g., starting with a previously design), portions of that skeleton are thickened and/or reinforced with braces until the desired strength and durability thresholds are fulfilled. As a result, stick-built components tend to have skeletons that vary considerably in thickness, with targeted areas being provided more mass for improved strength/stiffness. This highly specific and iterative stick-building process means that the resulting components may not be the most efficient possible designs.

Two areas of particular concerns relate to selected regimens testing a component's stiffness and ability to withstand fatigue. The former can be measured according to vehicle dynamic stiffness camber and caster, whereas the latter is often quantified via hardware test simulations known as bending and J-turn. Components capable of providing at least similar service life on most or all of these tests with an overall reduction in the weight of the component (both in comparison to current conventional designs) would be considered improved and more efficient.

Therefore, there is a need for vehicle components such as steering knuckles that are lighter in weight, that possess more uniform thickness throughout the their shell/skeleton and with a minimal number of reinforcements or ribs, and that more readily accommodate hard connection points in a variety of different suspension systems. Such components would be considered to be more efficient and, therefore, marked improvements over conventional stick-built designs.

### SUMMARY OF INVENTION

Aspects of suspension system connection components, such as steering knuckles, can be designed by taking inspiration from the shape of mussel shells. The resulting three dimensionally asymmetric body has only curved surfaces wherein the only flat planar surfaces presenting on the component are the hard connection points. When viewed down the axis along which the hub or spindle is aligned, the peripheral shape of the body will not include any straight lines. Most significantly, the thickness of the wall components at any given point will be substantially similar so as to vary by less than 25%, 15%, 10%, or 5% between the minimum and maximum points. The resulting, mussel-shaped body possesses superior strength, stiffness, and overall design efficiency in comparison to conventional, stick-built components.

The following description and the drawings disclose various exemplary aspects. While specific improvements and novel features may be expressly identified, it will be understood that skilled persons may be appreciate iterations and fundamental information that can all be discerned from this description and its drawings.

### DESCRIPTION OF THE DRAWINGS

The appended drawings form part of this specification, including any information disclosed or encompassed thereby (e.g., the relative positioning of components in the drawings, as well the shape, comparative dimensions, and sequence/ordering of elements or features). In these drawings, the mussel-shaped body is understood to have a curved contour with the “top” facing presenting as a convex surface and the “bottom” facing presenting as a concave surface. The “upper” portions are with reference to the top edge of the drawing sheets, whereas the “lower” portions are oriented toward the bottom edge. With reference to the specific sheets provided:

FIGS. 1A, 1B, and 1C illustrate, respectively speaking, top, bottom, and side plan views of a mussel-shape shell that served as inspiration for the three dimensionally asymmetric steering knuckles disclosed herein.

FIGS. 2A and 2B are complimentary three dimensional perspective views of opposing facings of a steering knuckle having mussel shaped body according to various aspects disclosed herein. Note the designations for directional axes, as indicated for FIGS. 2A and 2B, will apply to FIGS. 3 through 8B, and any one of these given axes is necessarily orthogonal to the other two.

FIG. 3 is a top plan view (i.e., taken normal to the x-axis) of the steering knuckle of FIG. 2A. Contouring lines are included to provide a better sense of the curvilinear surfaces shown thereon.

FIG. 4 is a corresponding bottom plan view (i.e., taken normal to the x-axis) of the steering knuckle of FIG. 3. Contouring lines are included to provide a better sense of the curvilinear surfaces shown thereon.

FIGS. 5A and 5B are complimentary, opposing perspective views of the top facing of the steering knuckle as shown in FIG. 3. Contouring lines are included to provide a better sense of the curvilinear surfaces shown thereon.

FIGS. 6A and 6B are complimentary, opposing perspective views of the top facing of the steering knuckle as shown in FIG. 4. Contouring lines are included to provide a better sense of the curvilinear surfaces shown thereon.

FIGS. 7A and 7B are complimentary, opposing side views (taken normal to the y-axis) of the steering knuckle as shown in FIG. 3 with the caliper ears and steering arm sides shown, respectively speaking. Contouring lines are included to provide a better sense of the curvilinear surfaces shown thereon.

FIGS. 8A and 8B are complimentary, opposing side views (taken normal to the z-axis) of the steering knuckle as shown in FIG. 3 with the upper ball joint and lower ball joint mounting sides shown, respectively speaking. Contouring lines are included to provide a better sense of the curvilinear surfaces shown thereon.

FIGS. 9A and 9B are similar to the views in FIGS. 2A and 2B, with enhanced shading provided to help further accentuated the curvature of the mussel-shaped body.

### DESCRIPTION OF INVENTION

Reference will now be made in detail to embodiments of the subject disclosure, examples of which are illustrated in the accompanying drawings. It is to be understood that other embodiments may be utilized, and structural and functional changes may be made without departing from the scope of the subject disclosure. Moreover, features of the embodiments may be combined, switched, or altered without departing from the scope of the subject disclosure, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the subject disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

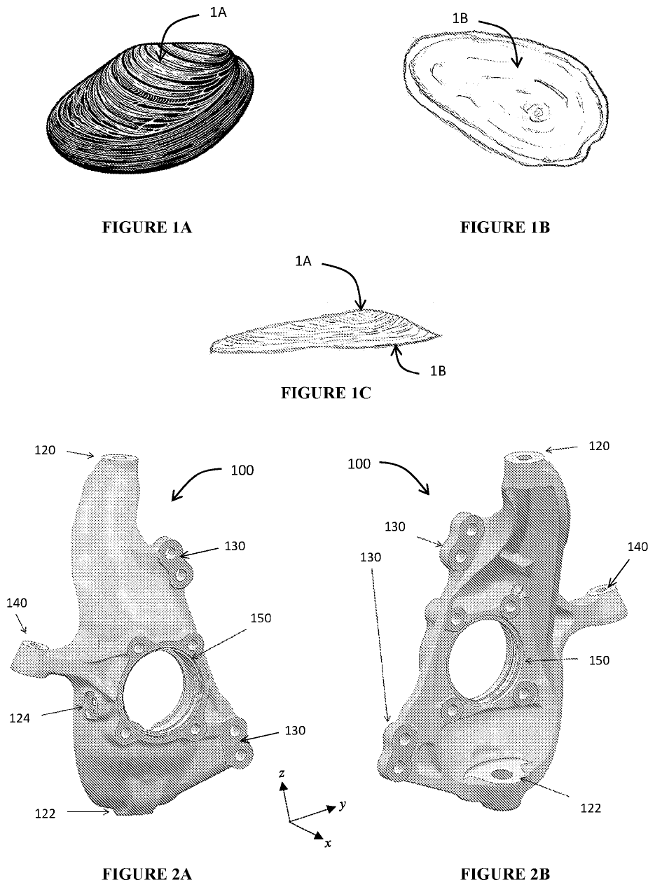

The inventors sought to reduce mass and enhance strength, stiffness, and durability by mimicking shapes found in natural objects (e.g., biomimicry). This approach can produce significantly lighter weight knuckles in comparison to conventional designs relying on the stick built approach. The resulting shapes that can be manufactured according to well known techniques for production at commercial scale. In this particular instance, all of the various aspects contemplated herein were inspired by the mussel shells depicted in FIGS. 1A through 1C.

In particular, the inventors appreciated that a mussel-shaped body would be capable of bearing significant loads applied normal to its top facing 1A (i.e., exerted along the x-axis), which is depicted in FIG. 1A and seen in the side view of FIG. 1C. Specifically, this shape is capable of sustaining distributing forces applied normal to the top facing along its uppermost peak and/or lowermost depression. At the same time, the three dimensional curving surfaces retain sufficient strength and stiffness along the periphery and/or within other axes (i.e., the y- and z-axes) so as to allow such a shape to serve as an improvement and replacement for conventionally designed, stick-built knuckles/suspension connection components. The bottom facing 1B, depicted in FIG. 1B and seen in the side view of FIG. 1C, is concaved to reduce mass usage while allowing for the ability to distribute loads. The resulting body possesses the necessary stiffness in all three dimensions to form the basic body of a steering knuckle.

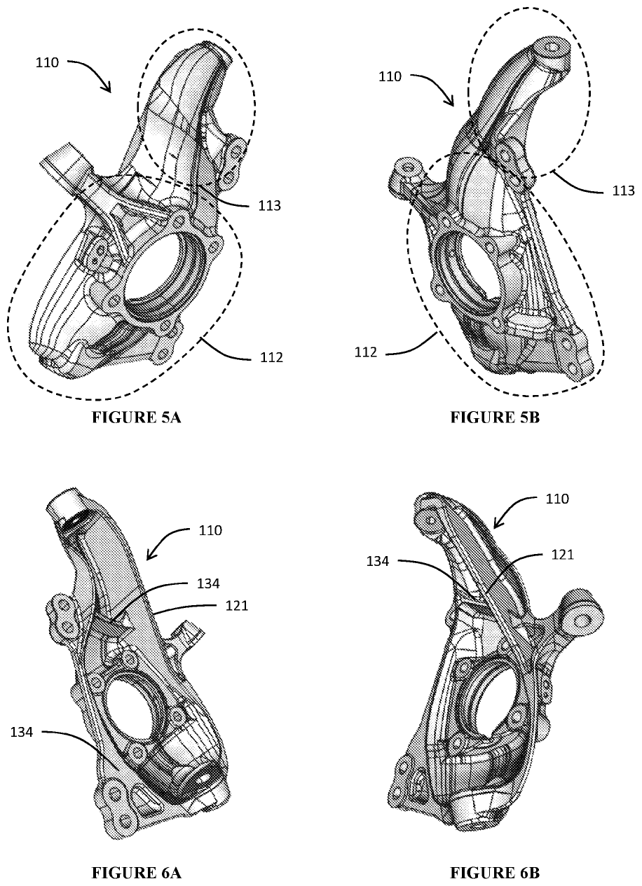

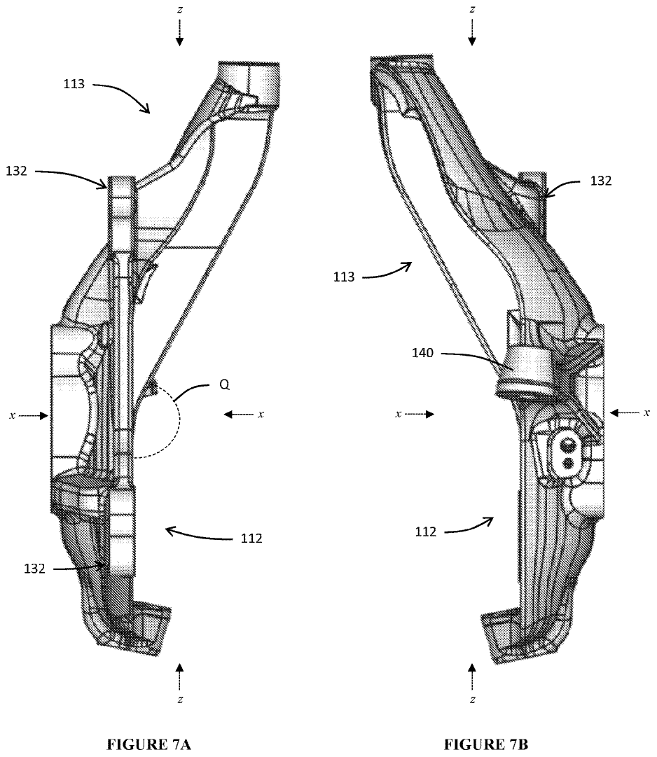

For the sake of clarity, as used throughout this description, symmetry is determined along any axis that bisects the body, including the three dimensional axes of the shell, as designated in FIGS. 2A through 8B. Thus, the mussel-shaped body used in various embodiments herein will not be symmetrical around any of its x-x, y-y, or z-z axes. In fact, the mussel-shaped body will not be symmetrical in any given plane or along any given axis. Thus, the mussel-shaped body is referred to as being three-dimensionally asymmetric.

Additionally, the mussel-shaped body will be understood as to not having any flat segments or sections within its load-bearing structure, as these constantly curved (i.e., non-flat) surfaces help to distribute loads per the biomimicry motivations noted above. Significantly, the hard connection points necessarily align in a single, flat plane to allow the knuckle to be affixed to the various vehicle systems (e.g., see FIGS. 2A and 2B), the remaining structures devoted to accommodating loads will not include any flat, planar sections. Thus, the mussel-shaped body is referred to as being non-planar, with it understood that hard connection points are excepted.

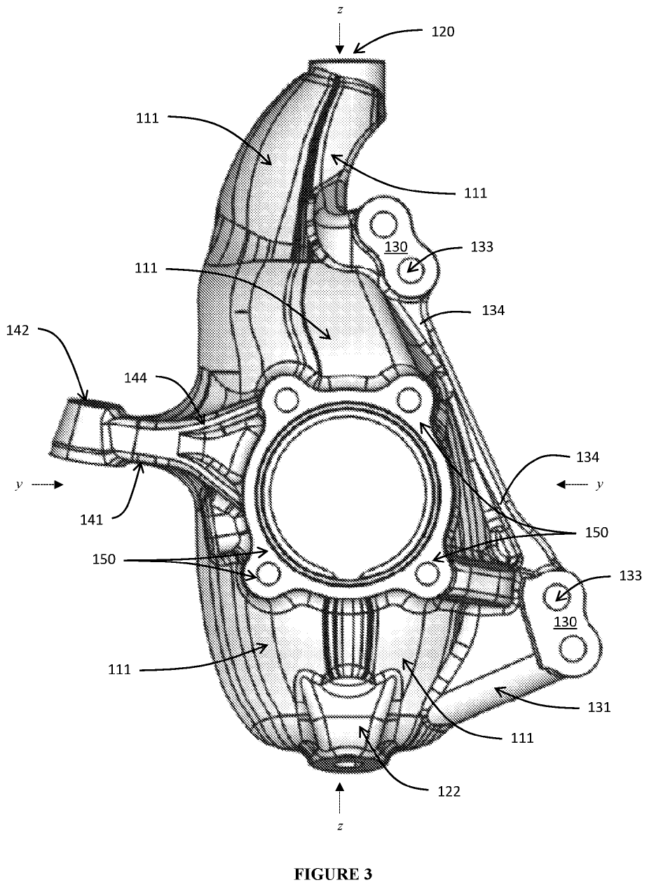

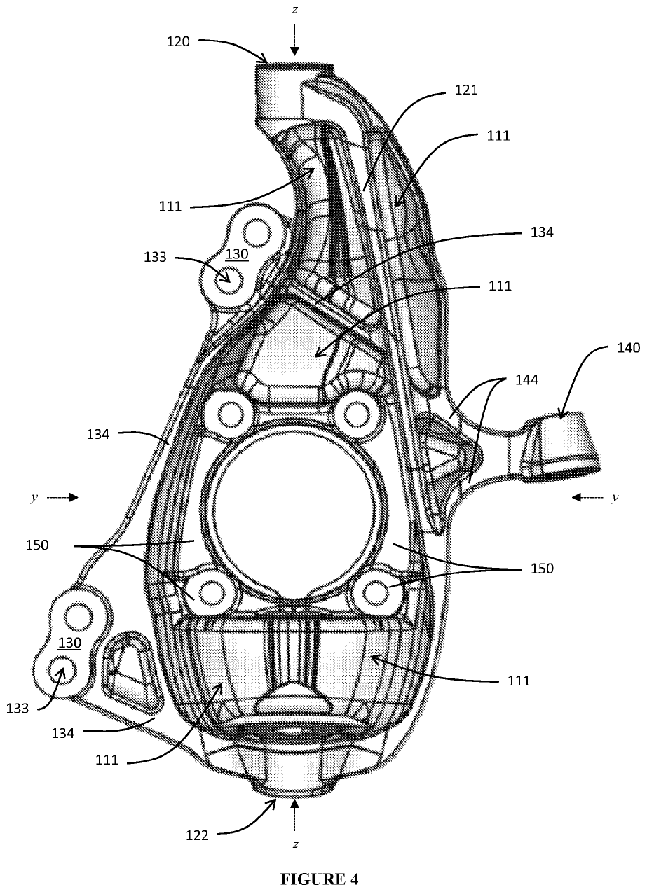

When viewed from the top or the bottom of the convex/concave surfaces (i.e., along a plane that is normal to the x-axis), the periphery of the weight distributing portions also will not include any straight lines, thereby imparting a non-linear shape along the periphery (as seen in FIGS. 3 and 4). As used herein, a “straight” line means a line segment that lacks any curves or angles along a contiguous section that constitutes up to 5% of that line segment's total length, thereby producing a “non-linear periphery” as illustrated in FIGS. 1A, 1B, 3, and 4. As above, exceptions are provided for the hard connection points, including any flanges or ribs visible in the top/bottom views that are needed to extend/create hard connection points (as discussed below); otherwise, the remainder of the periphery of the mussel-shaped body does not trace along any straight lines.

The mussel-shaped body is also characterized by a single layer construction where the curved sections have a thickness that is comparatively similar along its entire length and width. As such, aspects of the invention disclosed herein eliminate the need to use multi-layered bodies and/or the need to concentrate material to increase strength and stiffness, as can be found in some of the conventional designs noted above. Instead, the thickness of the mussel-shaped body will remain substantially constant or within a narrowly defined range. In some aspects, the body walls will be 7 mm thick, with positive or negative variations of no more than 1 mm. In other aspects, the variation between the thickest section of any part of the body in comparison to the thinnest will be no more than 25%.

Notably, the hard connection points present a special case. Thus, flanges or appendages may extend away from the mussel-shaped body so as to allow for discrete connection points along a predetermined plane. Thus, in some aspects, apertures configured to receive fasteners, bolts, or other coupling mechanisms may be aligned in or at an angle to the x-, y-, or z-axes. Depending upon the design of the suspension system in which the knuckle will be fitted, individual coupling points need not all align in the exact same plane. Examples of hard connection points include ball joint and/or sensor mountings, brake and steering system connections, and the hub/spindle mount (all as described below).

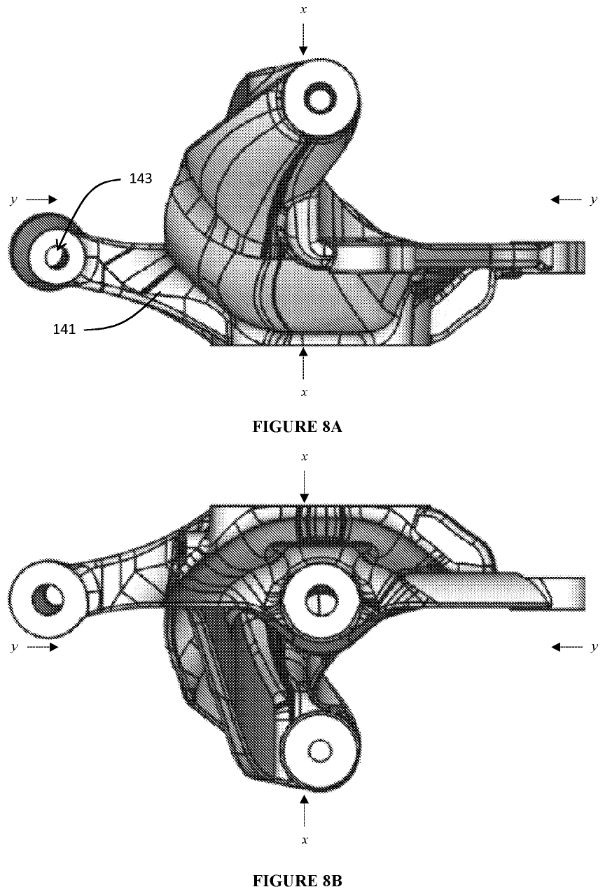

As a final generalized note, the mussel-shaped body in a knuckle according to various aspects of the invention will be oblong and/or elongated so as to generally include two discrete portions: a main connector and an angled extension. The main connector accommodates the hub or spindle hard connection point is generally aligned within top facing. The angled extension is integrally formed as an offshoot of the main connector so that it is not aligned in the same plane as the main connector. Instead, the angled extension is set at a slight angle, typically between 5° and 45° (see FIGS. 7A through 8B). In some aspects, one of the ball joint mountings (preferably the upper) will form a terminal edge of the angled extension, while a hub/spindle and lower ball joint mounting will be formed on the main connector. Caliper ears, sensor mountings (if any), and the steering arm may extend away from the main connector, usually with the caliper ears all aligned in a common spatial plane that is discrete from the plane in which the steering arm's connection point is aligned.

With reference to FIGS. 2A to 9B, a steering knuckle 100 having a mussel-shaped body 110 is shown. A plurality of hard connection points are provided, including upper ball joint mounting 120 and lower ball joint mounting 122, sensor mount 124, caliper ears 130, steering arm 140, and hub or spindle mount 150.

The mussel-shaped shell includes curved, asymmetric wall sections 111 where, excepting for the hard connection points, the wall sections constituting the body 110 are all curved so as to lack any extended flat planar sections. In turn, the body 110 consists of two contiguous portions: the main connector portion 112 and the angled extension portion 113. As is best illustrated in FIGS. 7A and 7B, the main connector 112 is aligned in a first planar dimension that is shown as being parallel to the z-axis, whereas the angular extension 113 is aligned in a second planar dimension that intersects at obtuse angle Q, that is relative to first planar dimension. This combination allows the knuckle to establish hard connection points as are often needs by the various disparate components found in vehicle suspension/steering systems.

It is important to note that body 110 has a shell-like shape, meaning it has an underside that is concave and an opposing top side that presents as a convex shape. This shell-like shape encompasses and carries through the main connector 112 and the angled extension 113 in order to provide for load distribution as described above. It further enables a single-layer wall construction for the entire mussel-shaped body 110, without the need for additional layered components, external reinforcement, or extended thickened wall sections (as are characteristic in conventional stick-built designs). Further, except for the hard connection points, none of the surfaces of the shell-like shape are flat, nor does the periphery (as can be seen in FIGS. 3 and 4) defining it include any straight lines. Stated differently, the periphery of the shell-like shape will be non-linear and the wall sections defining it will be constantly curving and of approximately similar thickness (i.e., ≤25% variability).

Notably, steering arm 140 includes a flange extension 141 terminating in an planar facing 142 that accommodates a steering connection aperture 143. Insofar as extension 141 must necessarily attach to the main connector portion 112, reinforcing structure 144 may include one or two thickened sections, presenting as linear or Y-shaped ribs.

In the same manner, because the caliper ears 130 tend to be offset from the mussel-shaped body 110, extension members 131 are needed to create the proper spacing. As with the steering arm 140, members 131 provide for a brake connector facing 132 to accommodate brake connection apertures 133. In some aspects, reinforcing section(s) 134 may be one or two thickened linear ribs or flat extension plates emanating directly away from and/or beneath the facing 132 so as to stabilize the ears 130 and separate but keep them connected to the body 110. AS Notably, a spine 121 may also extend at an angle from the reinforcing section 134, with the spine 121 serving as enhanced structural support for the upper ball joint mounting 120. In the same manner, the lower ball joint mounting 122 may be provided with a thickened wall 123.

Even with the presence of reinforcing section 134, spine 121, and wall 123 (collectively, maximal thickness sections), the entirety of the body 110 will still remain within the aforementioned wall thickness differentials. Thus, these elements will all still remain within 6 mm to 8 mm in thickness and/or within the 25% range of difference for the walls, with it being understood that the thickness of the walls will be measured at an axis that is normal to the curvature of the wall at the point of thickness being measured (i.e., the thickness is not measured along a single fixed axis such as the x-, y-, or z-axes, but instead is measured relative to the curvature of the wall at that point). Further, as shown by the illustrated embodiments, the maximal thickness sections constitute a small fraction (less than 5%) of the total surface area on the top and bottom facings.

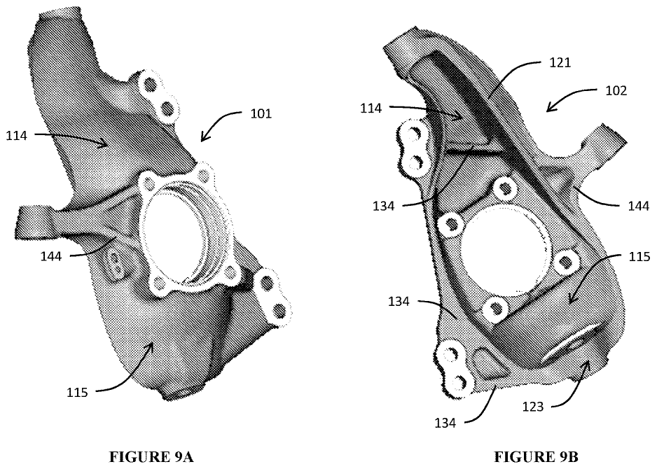

In this manner, the body 110 (as well as the main connector portion 112 and the angled extension portion 113) define the discrete curved wall sections highlighted in FIGS. 9A and 9B. In particular, top facing 101 is characterized by upper curved section 114 and lower curved section 115, while the bottom facing 102 is subdivided (owing, in part, to reinforcing sections 134, 144) into curved sections The resulting mussel-shaped body 110 has improved strength, stiffness, and durability while minimizing material usage and total mass (i.e., comparatively thin walls). In some aspects, the total weight of the knuckle 100 can be reduced by 10% and even up to 20% or even approaching 25% in comparison to conventional designs of comparable size and utility.

The strength, stiffness, and durability of inventive designs contemplated herein can be subjected to comparative tests against their conventional predecessors. A wide variety of testing regimens and specifications are utilized by vehicle manufacturers and regulatory authorities (such as the United States Department of Transportation), with the most relevant relating to the knuckle's expected fatigue life (i.e., longevity) and stiffness (as measured by Newton-meters/degree and/or Netwons/millimeter). Fatigue life is benchmarked according to bending, braking, and “J-turn” simulation tests. Stiffness is measured through various camber and caster tests. In each instance, the inventive designs were equivalent or outperformed prior designs.

In view of the foregoing, selected aspects of the invention include a steering knuckle useful for making interconnections with and among the suspension, steering, braking, and other vehicle systems. The knuckle is based on a body, also referred to above as mussel-shaped body, having a three dimensionally asymmetric shape with a non-linear periphery and a concave section including a main connector portion is aligned in a first planar dimension and an angled extension portion is aligned in a second planar dimension, with the second planar dimension intersecting the first planar dimension at an angle. The body is further defined by a single-layer wall with thickness that varies by less than 25% between minimum and maximum points of thickness of the single-layer wall, and the single-layer wall is constantly curving except for a plurality of hard connection points. Additional features may include one or any combination of the following:
wherein the angle is obtuse;
wherein the plurality of hard connection points includes a hub or a spindle positioned in the main connector portion and at least one of the following integrated with or extending from the angled extension portion: a steering arm, a sensor mount, one or more caliper ears, and a ball joint mounting;
wherein the plurality of hard connection points includes a ball joint mounting integrated with or extending from the main connector portion;
wherein the single-layer wall includes at least one reinforcing section and/or at least one maximal thickness section directly adjoining at least one of the hard connection points;
wherein a spine extends along the concave facing of the body from the main connector portion to the angled extension portion;
wherein a Y-shaped reinforcing section directly adjoins a steering arm extending away from the main connector portion;
wherein a thickened reinforcing section is integrated with opposing ball joint mounts integrate in each of the main connector portion and the angled extension portion;
wherein the thickness of the single-layer wall is substantially similar thickness throughout all of the main connector shell portion and all of the angled extension portion, including all hard connection points;
wherein the body consists of the single-layer wall; and
wherein the thickness of the single-layer wall is between 6 mm and 8 mm.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. A steering knuckle comprising:
a body having a three dimensionally asymmetric shape with a non-linear periphery and a concave section including a main connector portion is aligned in a first planar dimension and an angled extension portion is aligned in a second planar dimension, with the second planar dimension intersecting the first planar dimension at an angle;
wherein the body is defined by a single-layer wall with thickness that varies by less than 25% between minimum and maximum points of thickness of the single-layer wall; and
wherein the single-layer wall is constantly curving except for a plurality of hard connection points.

2. The knuckle of claim 1 wherein the angle is obtuse.

3. The knuckle of claim 1 wherein the plurality of hard connection points includes a hub or a spindle positioned in the main connector portion and at least one of the following integrated with or extending from the angled extension portion: a steering arm, a sensor mount, one or more caliper ears, and a ball joint mounting.

4. The knuckle of claim 3 wherein the plurality of hard connection points includes a ball joint mounting integrated with or extending from the main connector portion.

5. The knuckle of claim 3 wherein the single-layer wall includes at least one reinforcing section and/or at least one maximal thickness section directly adjoining at least one of the hard connection points.

6. The knuckle of claim 3 wherein a spine extends along the concave facing of the body from the main connector portion to the angled extension portion.

7. The knuckle of claim 1 wherein a Y-shaped reinforcing section directly adjoins a steering arm extending away from the main connector portion.

8. The knuckle of claim 1 wherein a thickened reinforcing section is integrated with opposing ball joint mounts integrate in each of the main connector portion and the angled extension portion.

9. The knuckle of claim 1 wherein the thickness of the single-layer wall is substantially similar thickness throughout all of the main connector shell portion and all of the angled extension portion, including all hard connection points.

10. The knuckle of claim 1 wherein the thickness of the single-layer wall is between 6 mm and 8 mm.
